(19) United States
(12) Patent Application Publication
(10) Pub. No.: US 2016/0199994 A1
(43) Pub. Date: Jul. 14, 2016

(54) INTERNAL BEAD SCARFER FOR PIPES AND TUBES

(71) Applicants: John Seminew, Lombard, IL (US); Jaroslaw Szpakowski, Schaumburg, IL (US)

(72) Inventors: John Seminew, Lombard, IL (US); Jaroslaw Szpakowski, Schaumburg, IL (US)

(21) Appl. No.: 14/594,463

(22) Filed: Jan. 12, 2015

(51) Int. Cl. B26D 3/00

(52) U.S. Cl. CPC B26D 3/00

(57) ABSTRACT

A process and system for continuously removing an internal weld bead from a pipe or tube formed with a longitudinal seam covered by the weld bead and extending along a longitudinal axis of the pipe or tube, in which an upper roller need not be used.

### RELATED APPLICATION

Pending U.S. Ser. No. 13/278,413, titled “External Bead Scarfer And Chopper For Pipes And Tubes,” is incorporated by reference in its entirety,

### BACKGROUND OF THE INVENTION

The present invention generally relates to scarfing machines used to remove the longitudinal weld seam or “bead” on pipes and tubes. More specifically, the invention relates to scarfing machines for safely and efficiently removing the internal diameter bead on pipes and tubes.

Various types of pipes and tubes are manufactured using many different processes. Often, pipes and tubes are manufactured by welding sheet stock in a longitudinally continuous manner, resulting in a weld bead extending longitudinally along an internal surface of the welded pipe or tube. Many applications require the removal of this internal weld bead to provide a smoother inner surface of the pipe or tube.

Conventionally, a stationary planing tool (“cutter”) is placed in the travel path of the moving, welded pipe or tube, to contact its internal surface and remove the internal weld bead from the pipe or tube in a continuous fashion. This process of continuously removing the weld bead from a moving pipe is known as “scarfing.” The removed weld head is hot, sharp and stringy. Areas adjacent the weld bead are subject to messy and dangerous weld splatter. Weld splatter often contains defects, such as excess carbon areas which, if rolled or mashed onto the pipe or tube surface by a roller associated with a scarfing device, for example, can cause defects in the pipe or tube.

Current devices for scarfing internal weld bead from pipes and tubes utilize a cutting tool guided by top and bottom rollers which maintain the cutting tool in position relative to the internal weld bead within the pipe or tube. See, e.g., U.S. Pat. Nos. 2,025,422; 2,714,383; 2,923,208; 4,710,078 and 5,056,972, each of which are incorporated by reference herein. The top rollers are in relatively close proximity to the scarfing operation, and thus are subject to weld splatter, and the hot temperatures involved, and accordingly require nearly continuous maintenance, as they often “freeze up” or wear out from use.

Accordingly, there is a need for an internal bead scarfing machine that overcomes the disadvantages involved in using roller heads with top rollers, while preserving the advantages of ID bead scarfers, and which can safely and efficiently remove and dispose of the internal weld bead from pipes and tubes, while doing so with minimal work stoppage.

### SUMMARY OF THE INVENTION

The objects mentioned above, as well as other objects, are solved by the present invention, which overcomes disadvantages of prior pipe manufacturing systems and machines used to remove internal weld beads, while providing new advantages not believed associated with such systems and machines.

In one preferred embodiment, a process is described for removing an internal weld bead from a pipe or tube that has been formed with a longitudinal seam extending along a longitudinal axis of the pipe or tube, the seam covered by the weld bead. A cutting bar is provided with a cutting device and no upper roller located on an upper side of the cutting bar. A pivotable arm is located on an opposing, lower side of the cutting bar. The pivotable arm includes a base and a lower roller, and the pivotable arm pivots about a pivot pin located on the cutting device. Rotational movement of the pivotable arm about the pivot pin 34 may be limited. A position of the lower roller may be adjusted relative to an adjacent inner surface of the pipe or tube, while also adjusting a position of the cutting device relative to the weld bead of the pipe or tube, to enable the cutting device to be positioned closely adjacent the weld bead, at an appropriate position to allow the cutting device to remove the weld bead in a continuous manner.

An actuator, such as in conjunction with a piston driven by an air or hydraulic cylinder, may be used to drive rotation of the pivotable arm about the pivot pin. This, together with a device(s) used to limit the rotational movement of the base of the pivotable arm, allows the arm to be set into a fixed, desired location. One device used to limit rotation of the pivotable arm may be a fastener, such as a set screw, in moveable contact with the pivotable arm; another device may be by employing notches in adjacent relationship to the arm, so that the arm is permitted to rotate in a metered, incremental fashion.

Preferably, the pipe or tube whose weld bead is to be removed is continuously moving in a generally horizontal direction, and the cutting bar may be positioned stationary relative to the moving pipe or tube.

In one preferred embodiment, the cutting device is a carbide cutting ring. Preferably, the cutting device is inclined at a relatively shallow angle to an upper surface of the cutting bar, in a range of between about 26°+/−5°, to avoid breaking or shearing the cutting device.

In another preferred embodiment of the invention, a cutting apparatus is provided for removing an internal weld bead from a moving pipe or tube that has been formed with a longitudinal seam extending along a longitudinal axis of the pipe or tube, in which the seam covers the weld bead. The cutting apparatus includes a cutting bar with a cutting device and no upper roller located on an upper side of the cutting bar. A pivotable arm is located on an opposing, lower side of the cutting bar. The pivotable arm includes a base and a lower roller, and the pivotable arm is capable of pivoting about a pivot pin located on the cutting device.

Means are provided for limiting rotational movement of the pivotable arm about the pivot pin. Such limiting means may be a fastener, such as a set screw, which is in moveable contact with a portion of the pivotable arm. Alternatively, such limiting means may be other mechanisms, such as notched locations in contact with the arm, to allow the arm to be moved in a metered, incremental fashion. Persons of ordinary skill in the art will recognize still other ways in which rotated of the arm may be limited and fixed in a desired position.

Using this cutting apparatus, a position of the lower roller may be adjusted relative to an adjacent inner surface of the pipe or tube, while adjusting as position of the cutting device relative to the weld bead of the pipe or tube, to enable the cutting device to be positioned closely adjacent the weld bead, at an appropriate position to allow the cutting device to remove the weld bead.

With the cutting apparatus, an appropriate actuator, such as in conjunction with a piston driven by air or hydraulics, may be used to drive rotation of the pivotable arm about the pivot pin.

Preferably, the pipe or tube is continuously moving in a generally horizontal direction, and the cutting bar is stationary relative to the moving pipe or tube.

The cutting device may take various forms, such as a carbide cutting ring. Preferably, the cutting device is inclined at a relatively shallow angle to an upper surface of the cutting bar, such as in a range of between about 26°+/−5°, to avoid breaking or shearing the cutting device during use.

### Definition of Claim Terms

The terms used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Scarf” means to continuously remove, by planing/cutting, an internal weld bead from a pipe or tube that was formed by welding along a longitudinal seam,

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIG. 1 is a top and side perspective view of a preferred embodiment of the internal pipe bead scarfing device of the present invention;

FIG. 2 is an enlarged top and side perspective view of a front portion of the device shown in FIG. 1;

FIG. 3 is a side and front perspective view of the portion of the device shown in FIG. 2

FIG. 4 is a side perspective view of the device shown in FIG. 3;

FIG. 5 is a side cross-sectional view of the device shown in FIG. 4;

FIGS. 6, 7 and 8 are bottom perspective views of a front portion of the device shown in FIG. 4, with the pivot arm in various positions;

FIGS. 6A, 7A and 8A are cross-sectional views taken alone reference lines 6A-6A, 7A-7A and 8A-8A, respectively, of the device with the pivot arm in various positions; and

FIG. 9 is a perspective view of the moving pipe, partially removed, with the stationary the cutting device of the present invention inside the pipe.

The components in the drawings are not necessarily to scale, emphasis instead being placed upon clearly illustrating the principles of the present invention. In the drawings, like reference numerals designate corresponding parts throughout the several views.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

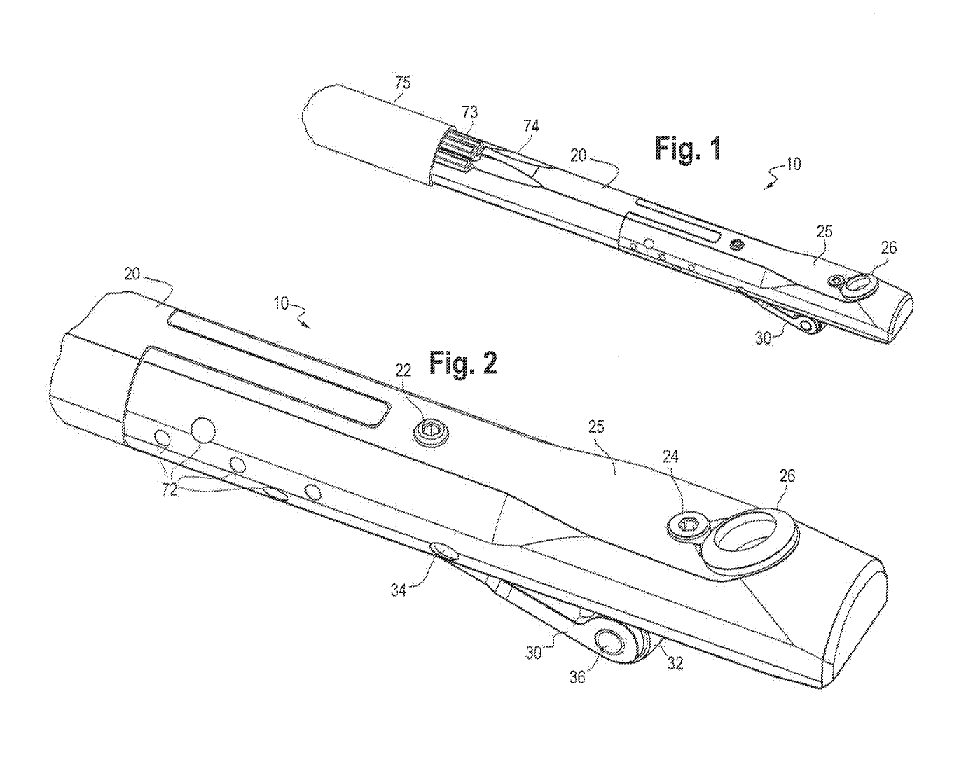

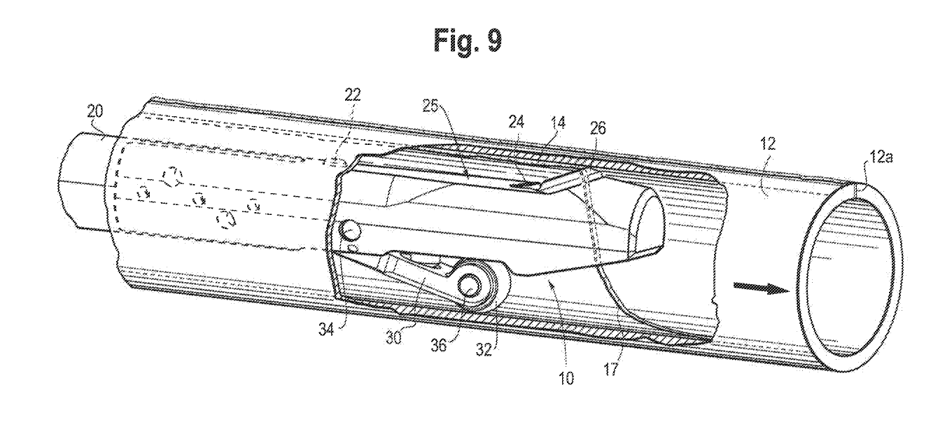

Referring first to FIGS. 1. and 9, a preferred. embodiment of the internal pipe bead scarfing device of the present invention (“the cutting bar”) is designated generally with the reference numeral 20. As is well known, scarfing device/cutting bar 20 may be rigidly supported within a moving pipe or tube 12 such as by using a clamping device or by other well-known means in the industry. Pipe or tube 12 has an internal longitudinal seam 12a covered by a weld bead 14 to be removed./scarfed, forming a removed “ribbon(s)” 17. During continuous travel of pipe or tube 12, scarfing device 20 may be used to remove the internal weld bead 14 (FIG. 9). A chopper, not shown, and which does not form a part of this invention, may then chop the continuous-length ribbon 17, which has been scarfed into pieces of a desired length, such as by using reciprocating cutter 56 disclosed in pending U.S. Ser. No. 13/278,413. After the ribbon is scarfed and chopped., it may be removed using deflector shields and/or conveying mechanisms to a scrap container, for example.

Still referring to FIGS. 1 and 2, the rear end of cutting device 20 may include a ferrite cover 75. Ferrite sticks 73 located on contours 74 cut into the outer surface of device 20 are used for the welding process (not the cutting process), as is well known in the art. Apertures 72 (FIG. 2) may he used to insert fasteners (not shown) that mount cutting head 25 to cutting bar 20.

Continuing to refer to FIGS. 1-2, in a preferred embodiment, scarfing/cutting device 20 may be a generally-tubular shaped metallic element 20, with a generally planar cutting head surface 25 mounting a cutting ring 26 located at one end of the cutting bar. Cutting ring 26 may be a carbide cutting tool designed to remove the internal bead of the pipe or tube. Cutting ring 26 may preferably be mounted on an angle to cutting head 25, as is well known in the art, to provide a desirable cutting angle. Cutting ring 26 preferably forms a relatively shallow angle with planar cutting bead surface 25, such as about 26°+/−5°, to avoid breaking or shearing the cutting ring. Clamping fastener 24 may be used to secure and retain cutting ring 26 to cutting head 25.

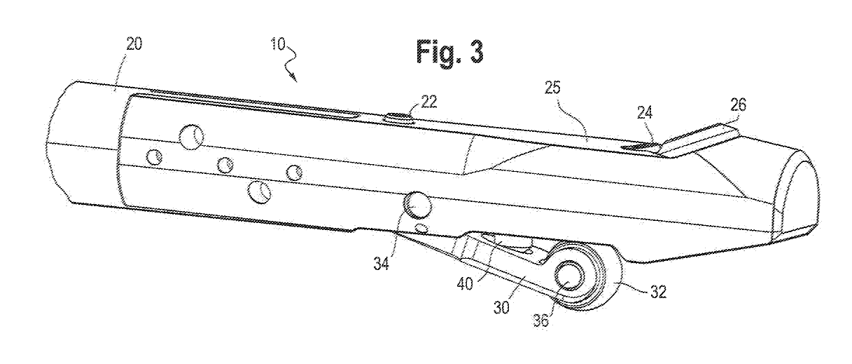

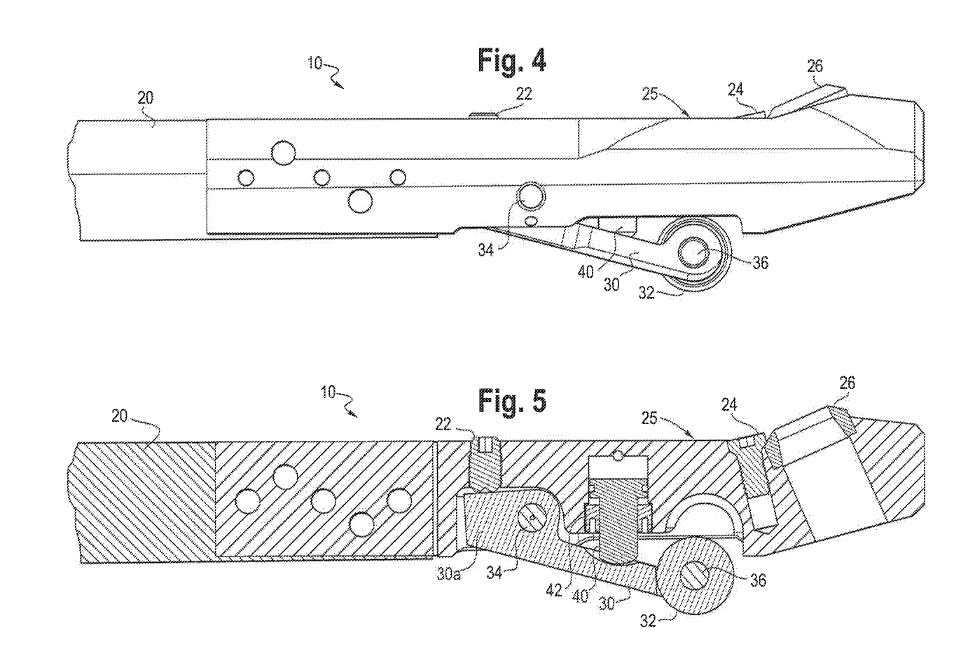

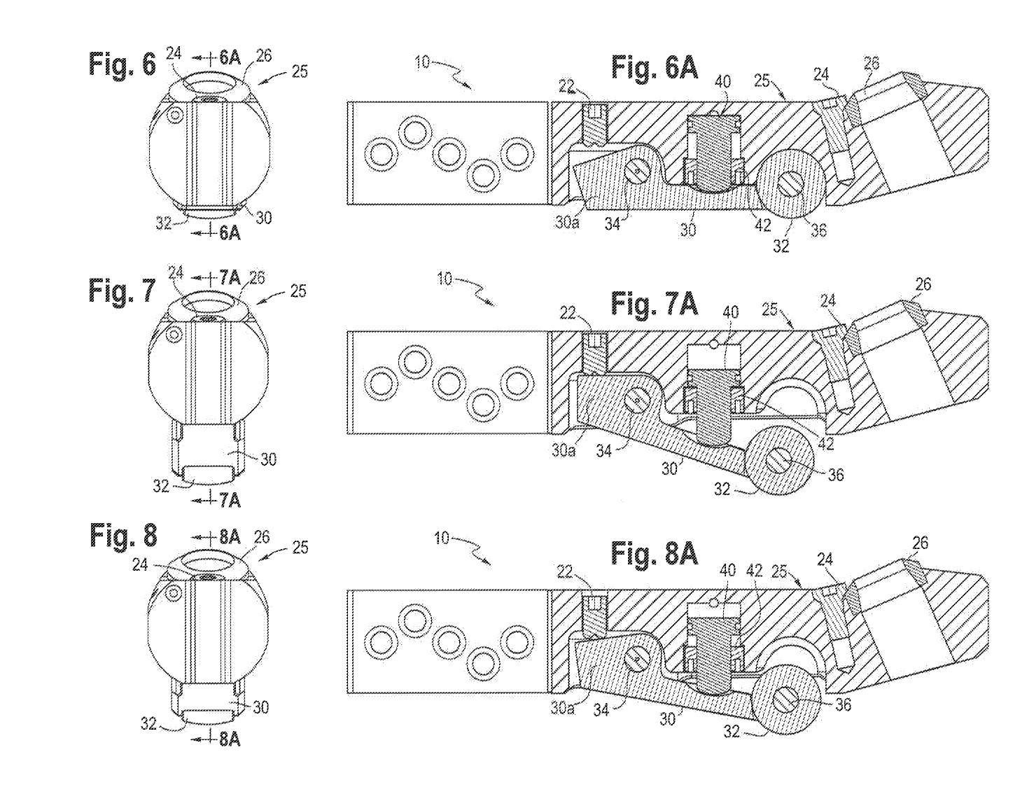

Referring to FIGS. 3-8, a lower portion of scarfing device 20 may be provided with a pivotable arm 30 having a base 30a rotating about pivot pin 34. Lower roller 32 may be mounted at a distal end of pivot arm 30, and roller 32 may be allowed to rotate about pivot 36. Lower roller 32 runs along an inner surface of pipe 12 (see FIG. 9). Arm 30 may be caused to pivot about pin 34 in a clockwise direction using a piston 40 driven by a hydraulic or air cylinder (not shown), causing actuator 42 to move piston 40 and adjust the height of lower roller 32 relative to cutting device 26. Adjusting fastener 22, such as a set screw (FIGS. 5 and 6A-8A) may be used to drive rotational movement of base 30a of pivotable arm 30 about pivot pin 34 in a counter-clockwise direction, thereby fixing the movement of arm 30 in position. Alternatively, rather than using an adjusting fastener to limit rotational movement of the arm that is otherwise provided by piston 40 (FIGS. 6A-8A), other means may be employed, such as providing the cutting bar with notched locations in contact with the arm, to permit the arm to more in a metered, incremental fashion, and to be locking into a desired position.

Referring to FIGS. 6A-8A and 9, in operation, scarfing device 20 may be located within a pipe or tube 12 having an internal, longitudinal seam 12 covered by protruding weld bead 14. Using actuator 42 to rotate arm 30 in a clockwise direction, and using adjusting fastener 22 to limit this rotation and cause arm 30 to be fixed in position, the height of lower roller 32 may he adjusted and selected to a fixed position, enabling cutting ring 26 to be positioned at a desireable height necessary to remove the weld bead without damaging other interior portions of the pipe, as best shown in FIG. 9.

FIG. 6A shows the arm in its maximum “up” position with fastener 22 in its uppermost (“backed-out”) position, and the air/hydraulic cylinder controlling the piston de-energized. FIG. 7A shows piston 40 completely extended, and fastener (e.g., stop screw) 22 in its uppermost, fully back-out position. FIG. 8A shows an intermediate position, in which fastener 22 adjusted in and piston 40 is pushing arm 30 in an intermediate downward direction.

It will be understood by those of ordinary skill in the art that it is preferred that the pipe travel in a horizontal plane, and that the scarfed ribbon also travel in a generally horizontal plane.

The present invention may be adapted for use by those of ordinary skill in the art to scarf the internal weld bead of virtually any longitudinally-welded pipe or tube, in a continuous fashion as the pipe or tube moves through the machine.

While the preferred embodiment shown in the drawings shows a single unit scarfing unit, it will of course be appreciated that dual or tandem scarfing units, or more than two, may be used as desired.

The above description is not intended to limit the meaning of the words used in the following claims that define the invention. Persons of ordinary skill in the art will understand that a variety of other designs still falling within the scope of the following claims may be envisioned and used, it is contemplated that future modifications in structure, function, or result will exist that are not substantial changes and that all such insubstantial changes in what is claimed are intended to be covered by the claims.

We claim:

1. A process for removing an internal weld bead (14) from a moving pipe or tube (12) that has been formed with a longitudinal seam (12a) extending along a longitudinal axis of the pipe or tube (12), the seam (12a) covered by the weld bead (14), comprising the steps of:
providing a cutting bar (20) having a cutting device (26) and no upper roller located on an upper side of the cutting; bar (20), and a pivotable arm. (30) located on an opposing, lower side of the cutting bar (20), the pivotable arm (30) including a base (30a) and a lower roller (32), and wherein the pivotable arm (30) pivots about a pivot pin (34) located on the cutting device;
limiting rotational movement of the pivotable arm (30) about the pivot pin (34);
adjusting a position of the lower roller (32) relative to an adjacent inner surface of the pipe or tube (12) while adjusting a position of the cutting device (26) relative to the weld bead (14) of the pipe or tube (12), to enable the cutting device (26) to be positioned closely adjacent the weld bead (14), at an appropriate position to allow the cutting device (26) to remove the weld bead (14); and
removing the weld bead in a continuous manner.

2. The process of claim 1, further comprising providing an actuator (42) for driving rotation of the pivotable arm (30) about the pivot pin (34), and using the actuator (42) to pivot the pivotable arm (30), and using the adjustment mechanism (22) to limit the rotational movement of the base (30a) of the pivotable arm (30).

3. The process of claim 1, wherein the pipe or tube (12) is continuously moving in a generally horizontal direction, and the cutting bar (20) is stationary relative to the moving pipe or tube (12).

4. The process of claim 1, wherein the cutting device (26) comprises a carbide cutting ring (26).

5. The process of claim 1, wherein the cutting device (26) is inclined at a relatively shallow angle to an upper surface of the cutting bar (20) in a range of between about 26°+/−5°.

6. The process of claim 1, wherein the step of limiting rotation of the pivotable arm (30) about the pivot pin (34) involves using an adjustment mechanism (22) in rnoveable contact with the pivotable arm (30).

7. A cutting apparatus for removing an internal weld bead (14) from a moving pipe or tube (12) that has been formed with a longitudinal seam (12a) extending along a longitudinal axis of the pipe or tube (12), the seam (12a) covered by the weld bead (14), comprising:
a cutting bar (20) having a cutting device (26) and no upper roller located on an upper side of the cutting bar (20);
a pivotable arm (30) located on an opposing, lower side of the cutting bar (20), the pivotable arm (30) including a base (30a) and a lower roller (32), and the pivotable arm (30) capable of pivoting about a pivot pin (34) located on the cutting device;
an adjustable mechanism limiting rotational movement of the pivotable arm (30) about the pivot pin (34);
wherein a position of the lower roller (32) may be adjusted relative to an adjacent inner surface of the pipe or tube (12), while adjusting a position of the cutting device (26) relative to the weld bead (14) of the pipe or tube (12), to enable the cutting device (26) to be positioned closely adjacent the weld bead (14), at an appropriate position to allow the cutting device (26) to remove the weld bead (14).

8. The cutting apparatus of claim 7, further comprising an actuator (42) for driving rotation of the pivotable arm (30) about the pivot pin (34).

7. cutting apparatus of claim 7, wherein the pipe or tube (12) is continuously moving in a generally horizontal direction, and the cutting bar (20) is stationary relative to the moving pipe or tube (12).

10. The cutting apparatus of claim 7, wherein the cutting device (26) comprises a carbide cutting ring (26).

11. The cutting apparatus of claim 7, wherein the cutting device (26) is inclined at a relatively shallow angle to an upper surface of the cutting bar (20) in a range of between about 26°+/−5°.

7. cutting apparatus of claim 7, wherein the adjustable mechanism comprises a fastener (22).

13. The cutting apparatus of claim 7, wherein the adjustable mechanism comprises notched locations communicating with pivotable arm (30) enabling pivotable arm (30) to be rotated in a metered, incremental fashion.
